(19) United States
(12) Patent Application Publication
(10) Pub. No.: US 2019/0251522 A1
(43) Pub. Date: Aug. 15, 2019

(54) REUSABLE FOOD OR BEVERAGE RELATED PRODUCT MANAGEMENT SYSTEM

(71) Applicant: GREEN GRUBBOX LLC, Seattle, WA (US)

(72) Inventor: Ted Leslie Wallis, Seattle, WA (US)

(21) Appl. No.: 16/271,177

(22) Filed: Feb. 8, 2019

Related U.S. Application Data
(60) Provisional application No. 62/628,689, filed on Feb. 9, 2018.

(51) Int. Cl. G06Q 10/00; G06Q 10/08; G06K 19/06; G06K 19/07; G06Q 30/06

(52) U.S. Cl. CPC G06Q 10/30; G06Q 10/087; G06Q 30/0633; G06K 19/06037; G06K 19/0723; G06K 19/06028

(57) ABSTRACT

Systems and methods for distributing reusable takeout food or beverage related products, such as food containers, through a communicative process between consumers, vendors and designated return stations, also referred to herein as “drop stations.” The system may include a mobile application executable on mobile devices that communicates with a server connected to a network and a database accessible by the server that includes a list of approved users, vendors, and return stations, which are physical locations to which the consumers may return the containers after use. Consumers may operate their mobile devices executing a mobile application to scan or “checkout” a container at the time of purchase of a food item. Containers may be scanned by a scanning device prior to being provided to a vendor, which scan identifies the type of container being checked out to the vendor.

### BACKGROUND

### Technical Field

The present disclosure generally relates to methods, systems and devices for food or beverage related product inventory control, for example, between consumers, vendors, and a variety of return stations.

### Description of the Related Art

Takeout food is consumed daily by millions of people during the course of the work week. Typically, consumer food items are packaged in single use containers which are responsible for large amounts of municipal solid waste. This waste must be managed by municipalities to remove and dispose of the waste. Generally, food waste packaging is typically deposited in waste bins designated for one or all of the following: (1) landfill waste, which is either deposited or transported to a designated landfill location; (2) recycling, which is either processed or transported to a recycling facility; or (3) a composting facility, which may compost the food container waste and resell the composted material to other consumers. All of the aforementioned options require energy consuming transporting and processing mechanisms that undesirably result in massive amounts of energy and scarce resource consumption.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIGS. 1A-1B are a schematic diagram of an exemplary food container management system, according to one illustrated implementation.

FIG. 2A illustrates an example screenshot depicting a vendor map view of a mobile application of a food container management system, according to one illustrated implementation.

FIG. 2B illustrates an example screenshot depicting a vendor list view of a mobile application of a food container management system, according to one illustrated implementation.

FIG. 2C illustrates an example screenshot depicting a selected vendor view of a mobile application of a food container management system, according to one illustrated implementation.

FIG. 3 is a block diagram of an example processor-based device used to implement one or more of the functions described herein, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to systems and methods for distributing reusable food or beverage related products, such as takeout food or beverage containers (“containers”), through a communicative process between consumers, vendors and designated return stations, also referred to herein as “drop stations.” The system may include a mobile application (“mobile app”) executable on mobile devices that communicates with a server connected to a network and a database accessible by the server that includes a list of approved users (e.g., members), also referred to herein as consumers, vendors (e.g., restaurants), and return stations, which are physical locations to which the consumers may return the products after use. As discussed further below, the examples provided herein are provided in the context of food containers, but it should be appreciated that the implementations of the present disclosure are not so limited, and may be used with numerous types of reusable food or beverage related products.

As discussed further below, in operation, consumers may operate their mobile devices (e.g., smart phones) executing a mobile application to scan or “checkout” a container at the time of purchase of a food item. As a non-limiting example, the user may utilize a machine-readable symbol technology (e.g., QR code, 1D or 2D barcode) or a wireless technology (e.g., NFC code or RFID code) to scan or checkout the container from a vendor's inventory. In at least some implementations, containers may be scanned by a scanning device (e.g., QR code, NFC code, or RFID code) prior to being provided to a vendor, which scan identifies the type of container being checked out to the vendor. The scan may also assign a date and time stamp notification. As used herein, the terms “scan” and “code” may refer to any suitable technology for identifying and tracking objects, including technologies that utilize optical detection (e.g., QR codes, barcodes), RF detection (e.g., NFC, RFID), or other types of technologies.

Once scanned, the inventoried container may be added to the vendor's current inventory. Subsequently, consumers may checkout the containers when they purchase food from the vendor by utilizing a mobile device (e.g., smartphone, other scanning device) to scan a code (e.g., QR, NFC and/or RFID) displayed or otherwise present on the container, for example, by using a camera or an NFC reader of a mobile device. The food container management system may then logically transfer the code from the vendor's inventory to the consumer's user account and deduct the container from the vendor's inventory.

When the consumer is finished with the container (e.g., after eating at a food court), the consumer may return the checked out container to a drop station or receptacle that is strategically located in or near the user's place of business and/or near one or more of the vendors that the user frequents. For example, the drop stations may be placed near a seating area of a food court, park, office space, or other area where consumers may consume food nearby. In at least some implementations, the check-in process may utilize a scanner (e.g., QR, NFC or RFID scanner) that is mounted inside the drop station that is operative to scan the containers once positioned in or on the drop station for subsequent reuse.

In at least some implementations, the drop station may include control circuitry (e.g., processor, microcontroller) and may include one or more communications interfaces, such as Wi-Fi®, Bluetooth®, Power over Ethernet (PoE), or any other networking interface, which allows communication between the drop station and other components of the food container management system (e.g., web server, mobile devices). Once the drop station scans or otherwise reads a code on the container, at least one processor of the drop station may communicate through a web server to a database server and deduct the container from the user account, thereby signaling that the user that checked out the container has returned the container to the drop station.

A reusable food container management system may be summarized as including a mobile application downloadable to a user mobile device (e.g., smart phone, tablet computer) that is capable of reading unique identifier codes (e.g., QR code, RFID code) that, when scanned, checks out a reusable container that contains food or a beverage purchased by the user from a vendor. The container may be recorded or assigned to a created user profile or account that is stored on a database server which is accessed through a web server via one or more networks (e.g., Internet). In at least some implementations, the container may be checked out by scanning a unique code (e.g., barcode, RFID code) that is affixed to the container which is stored on a database server accessible through a web server. The container may also include a code that has been pre-scanned and logically associated with the account inventory for a particular vendor prior to being delivered to the vendor, or upon delivery to the vendor. In such implementations, the user may scan the code on the container once during purchase of food from the vendor to have the code of the container logically associated with the user's account. In at least some implementations, the user has the ability to checkout multiple containers at a vendor visit since the containers are each associated with a unique code.

In at least some implementations, a reusable food container management system may also process vendor inventory of the containers once a unique identifying code is scanned. This may include a vendor inventory control system that deducts the specific style or shape of containers based on a customer's purchase history relative to meal choices the customer has made in the past. The vendor inventory control system may also make the same deduction by scanning a unique code that is positioned on (e.g., printed, affixed) to the container. As a non-limiting example, the vendor inventory control system may be accessed through a user interface (UI) on a web site or application connected to a webserver that is connected to a database server where the vendor information is stored.

In at least some implementations, a drop return station that receives the used containers from the consumers may include a tray and a tray lowering mechanism that is supported by a plurality (e.g., four) of extension springs attached to a support bar in the top of the drop station. The tray may then automatically lower as more containers are returned by consumers. In at least some implementations, the drop station may be operative to accommodate a plurality (e.g., two, five, twenty) of differently size containers. The drop station tray lowering mechanism may employ a sensor (e.g., level measurement sensor, weight measurement sensor, container count sensor) that is operative to generate an overfill condition alert to the food container management system. As an example, the sensor may send various alerts depending the severity of the overfill condition. The alert notifications may be sent to an administrator of the food container management system (e.g., via a UI thereof). The notification may additionally or alternatively be sent to one or more mobile devices (e.g., smart phones) utilizing a version of the mobile application that personnel associated with the food container management system may use to maintain the integrity of the drop station. The food container management system may autonomously or manually use the notifications to control the routing of pickup personnel (e.g., drivers, cyclists) dependent on the overfill condition of one or more drop stations.

The UI may have a running list of drop station locations that provides real-time levels of the containers in the various drop stations throughout a region (e.g., city, neighborhood, other region). As discussed above, the drop stations may also utilize an inventory scanner (e.g., QR code, RFID) inside the drop station to “check in” or release the containers associated with QR codes from the users' accounts. The scanner may also be used to sense the number of containers present in the drop station to facilitate the notifications discussed above.

In at least some implementations, the user account may impose a limit on the number of containers the user may have checkout at a given time. In at least some implementations, the checkout limit is four containers. If the checkout limit is reached, the user may be temporarily prevented from checking out additional containers until the user returns containers and the user is again below the checkout limit. In at least some implementations, the user may be given the option to purchase the container if, for example, the user lost the container or the user otherwise wishes to keep the container for later use.

As discussed above, in at least some implementations the drop stations may utilize a mounted scanner (e.g., QR code reader, NFC code reader, or RFID code reader) that may scan codes applied to the containers as they are returned. The drop station may utilize a communications interface (e.g., PoE, Bluetooth®, Wi-Fi®) to communicate to a web server and a database server via a wired and/or wireless connection. Once the scan is complete for a container, the container may be logically removed from the user account profile and assigned back into inventory of the food container management system.

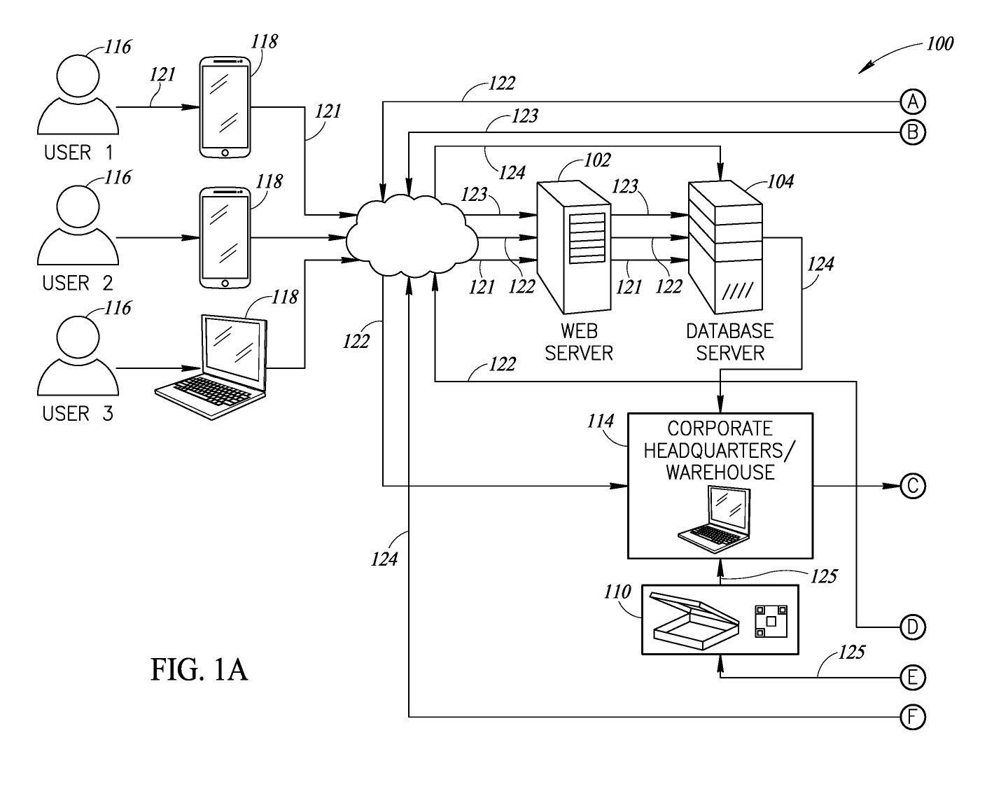

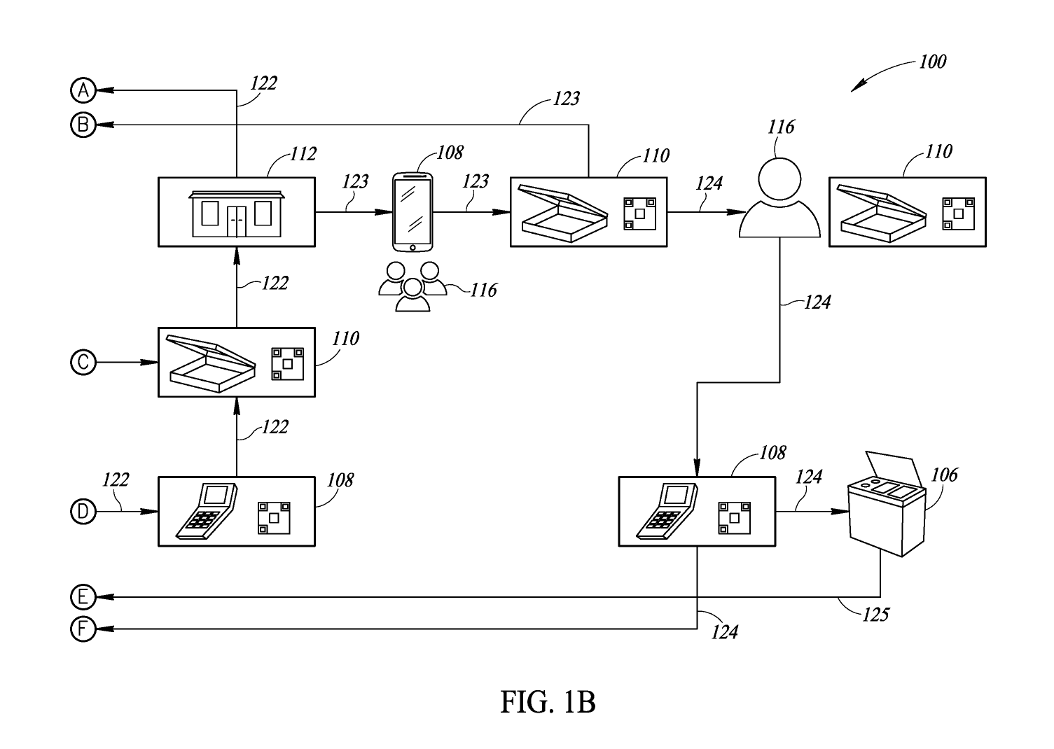

FIGS. 1A-1B provide a schematic diagram of an exemplary food container management system 100. The various components of the system 100 include a web server 102, a database server 104, return or drop stations 106 (FIG. 1B), scanning devices 108 (also labeled 118), and reusable containers 110. The physical locations shown in FIGS. 1A-1B include a vendor location 112 (e.g., restaurant, food truck), which is representative of one of any number of vendor locations, and a central warehouse or facility 114, which may be one of a plurality of facilities positioned in our around a region (e.g., city, state, country).

Also shown in FIGS. 1A-1B are users or members 116 and their associated mobile devices 118. An example of the process flow for the food container management system 100 is indicated by acts 121-125 labeled in FIGS. 1A-1B.

At act 121, the user 116 downloads a mobile application and begins enrollment through the database 104 of the food container management system 100. Once the user 116 is registered, the user may visit a participating vendor 112 to purchase food items. For example, a user may visit a participating vendor in a food court of an office building or shopping center.

At act 122, the vendor 112 may order QR coded and/or RFID coded containers 110, or containers that are associated with any type of machine readable symbol, using the mobile or web application of the food container management system 100. The vendor's order is then processed by delivering pre-scanned containers to the vendor business location, where the containers 110 are entered into vendor's container inventory. The codes associated with the pre-scanned containers are reflected on the vendor backend as being associated with the vendor. In at least some implementations, the system 100 may track the inventory of the vendor and automatically re-order containers based on anticipated demand.

At act 123, a user 116 visits a vendor 112, informs the vendor of the user's membership, and orders food to be served in a reusable container 110 of the food container management system 100. The user then scans the code displayed on or otherwise present in or on the container 110 using the user's mobile device 118 (e.g., smart phone) or a scanning device provided by the vendor. Once the code has been read, the code for that particular container is transferred from the vendor's account to the user account and is reflected as a “checked out” container on the user account section of the mobile application.

At act 124, when the user completes their meal they may consult the mobile application to find the nearest drop station 106 to return the checked out container. For example, the mobile application may utilize the user's current location obtained by the mobile device to inform the user of nearby drop stations via a user interface (e.g., maps, text, images). Once located, the user returns the container by depositing the container in or on the drop station. For example, the user may place the container face up on a tray lowering mechanism of a drop station, as discussed above. As the tray automatically lowers, the QR code and/or RFID code may be scanned by a mounted reader or camera placed inside the drop station. The QR and/or RFID code reader may be powered by battery, PoE, Wi-Fi® or Bluetooth®, for example. Once scanned, the QR and/or RFID code is released from the user account and reflected as a checked in container by the system. The camera or scanning device of the drop station may report the QR code and/or RFID code transfer transaction and enters the container back into general company inventory.

Also at act 124, the QR and/or RFID code may also be manually scanned by a company administrator using either an administrator mobile device or a QR or RFID code scanner that also reports the transfer transaction back into company inventory.

At act 125, personnel (e.g., driver, cyclist) associated with the food container management system 100 may return the scanned and released containers 110 to the central facility (e.g., a nearest facility) where the containers are washed, sanitized, and returned to general inventory for reuse by vendors and consumers.

If a container 110 is checked out longer than a determined period (e.g., 2 hours, 24 hours, one week), the system 100 may send the user text message, mobile phone notification or email indicating the container is still checked out and should be returned to a drop station. As noted above, in at least some implementations, the system 100 may allow users to keep a certain number (e.g., 3, 5, 10) containers checked out at a time.

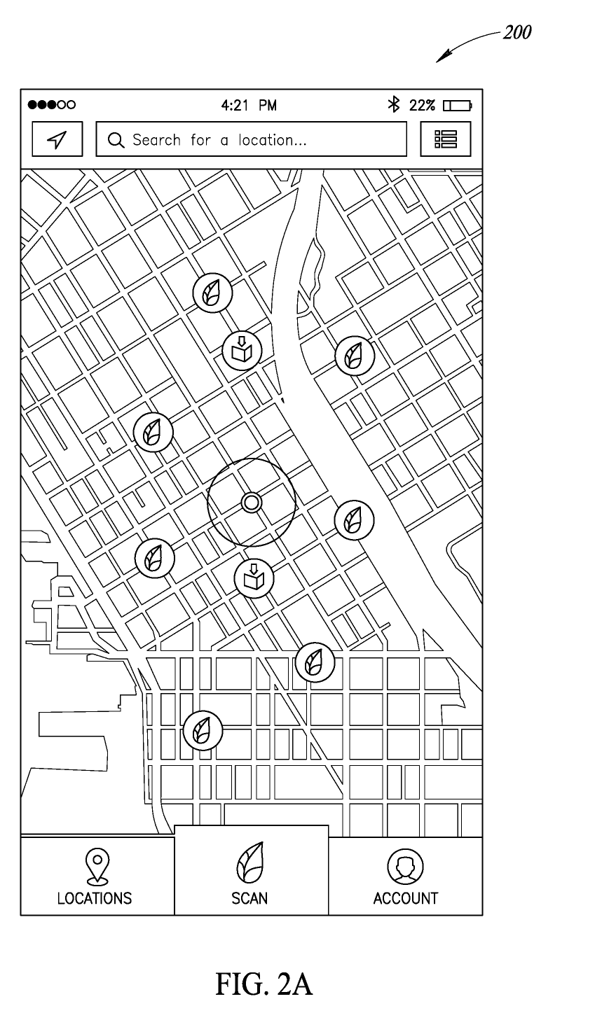

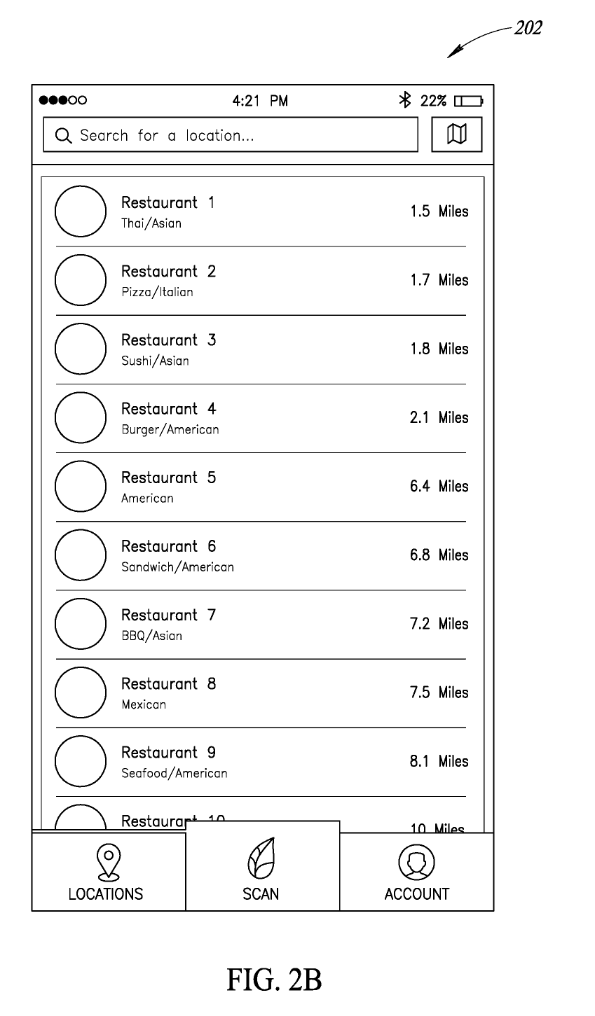

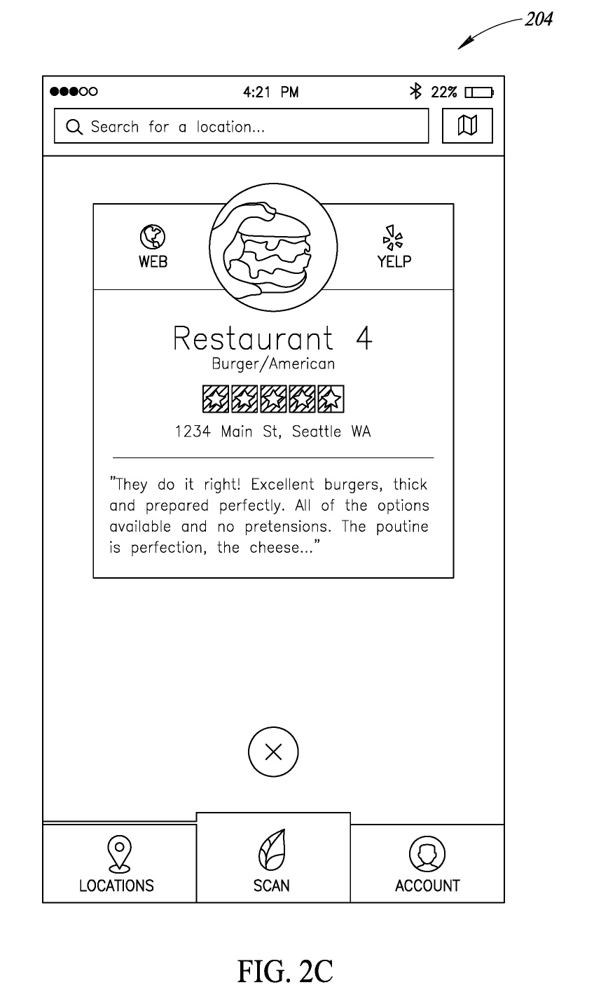

FIG. 2A illustrates an example screenshot 200 depicting a vendor map view of a mobile application of a food container management system. FIG. 2B illustrates an example screenshot 202 depicting a vendor list view of a mobile application of a food container management system. FIG. 2C illustrates an example screenshot 204 depicting a selected vendor view of a mobile application of a food container management system.

Although the discussion above relates to management of reusable food containers as an example, it should be appreciated that the implementations discussed herein may be used with many other reusable food or beverage related products. Example food or beverage related products that may be managed according to the present disclosure include, but are not limited to, beverage containers (e.g., reusable coffee cups), food utensils (e.g., reusable spoons, forks, knives, chopsticks), food or beverage packaging or carrying supplies, insulated containers or bags, grocery containers or bags, cold packs, heat packs, food or beverage accessories, etc.

### Example Processor-Based Device

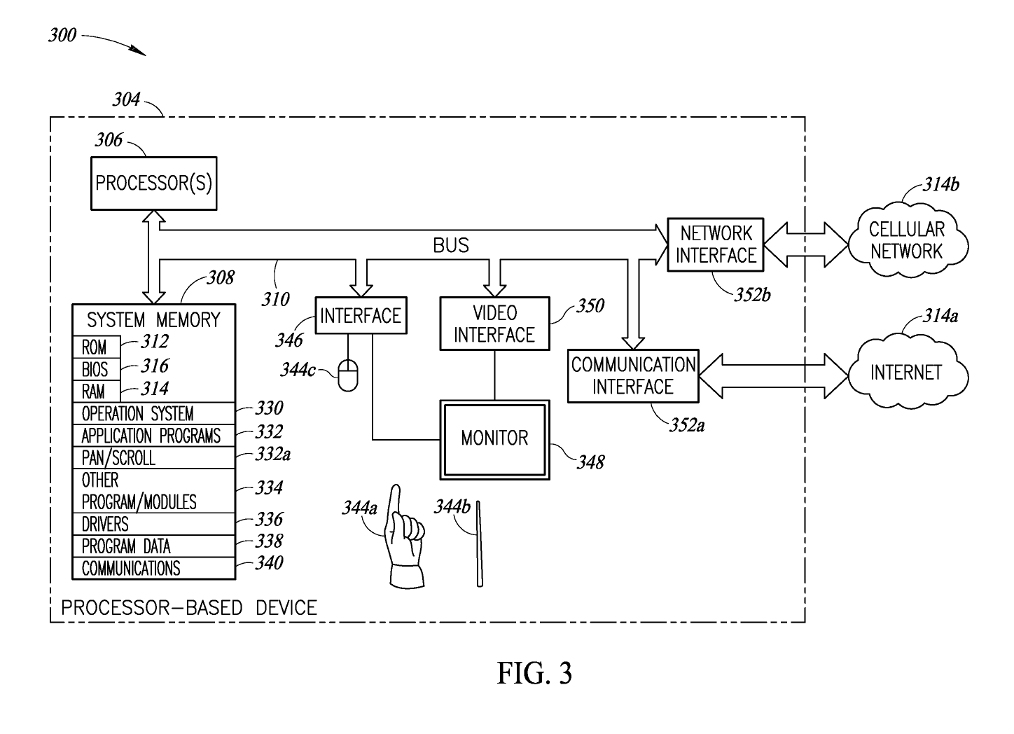

FIG. 3 shows an environment 300 that includes a processor-based device 304 suitable for implementing various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 304 may include one or more processors 306, a system memory 308 and a system bus 310 that couples various system components including the system memory 308 to the processor(s) 306. The processor-based device 304 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 1012 and random access memory (“RAM”) 315. A basic input/output system (“BIOS”) 316, which can form part of the ROM 312, contains basic routines that help transfer information between elements within processor-based device 304, such as during start-up. Some implementations may employ separate buses for data, instructions and power.

The processor-based device 304 may also include one or more solid state memories, for instance flash memory or a solid state drive, which provides nonvolatile storage of computer-readable instructions, data structures, program modules and other data for the processor-based device 304. Although not depicted, the processor-based device 304 can employ other nontransitory computer- or processor-readable media, for example a hard disk drive, an optical disk drive, or memory card media drive.

Program modules can be stored in the system memory 308, such as an operating system 330, one or more application programs 332, other programs or modules 334, drivers 336 and program data 338.

The application programs 332 may, for example, include panning/scrolling 332a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 332a may, for example, be stored as one or more executable instructions. The panning/scrolling logic 332a may include processor and/or machine executable logic or instructions to generate user interface objects using data that characterizes movement of a pointer, for example data from a touch-sensitive display or from a computer mouse or trackball, or other user interface device.

The system memory 308 may also include communications programs 340, for example a server and/or a Web client or browser for permitting the processor-based device 304 to access and exchange data with other systems such as user computing systems, Web sites on the Internet, corporate intranets, or other networks as described below. The communications programs 340 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 3 as being stored in the system memory 308, the operating system 330, application programs 332, other programs/modules 334, drivers 336, program data 338 and server and/or communications programs 340 (e.g., browser) can be stored on any other of a large variety of nontransitory processor-readable media (e.g., hard disk drive, optical disk drive, SSD and/or flash memory).

A user can enter commands and information via a pointer, for example through input devices such as a touch screen 348 via a finger 344a, stylus 344b, or via a computer mouse or trackball 344c which controls a cursor. Other input devices can include a microphone, joystick, game pad, tablet, scanner, biometric scanning device, etc. These and other input devices (i.e., “I/O devices”) are connected to the processor(s) 306 through an interface 346 such as touch-screen controller and/or a universal serial bus (“USB”) interface that couples user input to the system bus 310, although other interfaces such as a parallel port, a game port or a wireless interface or a serial port may be used. The touch screen 348 can be coupled to the system bus 310 via a video interface 350, such as a video adapter to receive image data or image information for display via the touch screen 348. Although not shown, the processor-based device 304 can include other output devices, such as speakers, vibrator, haptic actuator, etc.

The processor-based device 304 may operate in a networked environment using one or more of the logical connections to communicate with one or more remote computers, servers and/or devices via one or more communications channels, for example, one or more networks 314a, 314b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 304 may include one or more wired or wireless communications interfaces 352a, 352b (e.g., cellular radios, WI-FI radios, Bluetooth radios) for establishing communications over the network, for instance the Internet 314a or cellular network 314b.

In a networked environment, program modules, application programs, or data, or portions thereof, can be stored in a server computing system (not shown). Those skilled in the relevant art will recognize that the network connections shown in FIG. 3 are only some examples of ways of establishing communications between computers, and other connections may be used, including wirelessly.

For convenience, the processor(s) 306, system memory 308, network and communications interfaces 352a, 352b are illustrated as communicably coupled to each other via the system bus 310, thereby providing connectivity between the above-described components. In alternative implementations of the processor-based device 304, the above-described components may be communicably coupled in a different manner than illustrated in FIG. 3. For example, one or more of the above-described components may be directly coupled to other components, or may be coupled to each other, via intermediary components (not shown). In some implementations, system bus 310 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including U.S. Provisional Patent Application Ser. No. 62/628,689, filed Feb. 9, 2018 are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operating a food container management system, the method comprising:
receiving, by at least one processor, a request for a plurality of reusable food containers from a vendor;
logically associating, by the at least one processor, each of a plurality of reusable food containers with a vendor account of the vendor in at least one nontransitory processor-readable storage medium responsive to receiving the request for the plurality of reusable food containers from the vendor;
providing the plurality of reusable food containers to the vendor;
receiving, by the at least one processor, a request for use of one of the plurality of reusable food containers associated with the vendor account from a user; and
logically associating, by the at least one processor, the one of the reusable food containers with a user account of the user in the at least one nontransitory processor-readable storage medium responsive to receiving the request for use of the one of the reusable food containers.

2. The method of claim 1, further comprising:
receiving, by the at least one processor, an indication that the user has returned the reusable food container to a drop station after use of the reusable food container; and
logically dis-associating, by the at least one processor, the returned reusable food container with the user account of the user.

3. The method of claim 2 wherein receiving an indication that the user has returned the reusable food container to a drop station comprises:
receiving an indication from a mobile device that has read a machine readable symbol associated with the reusable food container; or
receiving an indication from a reader of the drop station that has read a machine readable symbol associated with the reusable food container.

4. The method of claim 1 wherein logically associating each of a plurality of reusable food containers with a vendor account comprises, for each of the plurality of reusable food containers, reading a machine readable symbol associated with the reusable food container.

5. The method of claim 4 wherein reading a machine readable symbol comprises reading an optical machine readable symbol with an optical reader or reading a radio frequency machine readable symbol with a radio frequency machine readable symbol reader.

6. The method of claim 1 wherein receiving a request for use of one of the plurality of reusable food containers associated with the vendor account from a user comprises receiving an identifier associated with the one of the plurality of reusable food containers from a mobile device of the user.

7. The method of claim 6 wherein receiving an identifier associated with the one of the plurality of reusable food containers comprises receiving an identifier obtained by the mobile device of the user by reading a machine readable symbol associated with the reusable food container.

8. The method of claim 7 wherein reading a machine readable symbol by the mobile device comprises reading the machine readable symbol with an optical reader or a radio frequency reader.

9. The method of claim 8 wherein reading the machine readable symbol comprises reading at least one of a barcode, a QR code, or an RFID tag associated with the reusable food container.

10. The method of claim 1, further comprising:
tracking, by the at least one processor, an inventory of reusable food containers logically associated with the vendor; and
autonomously re-ordering reusable food containers based on the tracked inventory.

11. The method of claim 1, further providing:
providing, by the at least one processor, an indication of a location of a drop station to the user, the drop station operative to receive reusable food containers after users have consumed the food contained therein.

12. The method of claim 1, further comprising:
receiving, by the at least one processor, an indication that the user has returned the reusable food container from a drop station.

13. The method of claim 1, further comprising:
receiving, by the at least one processor, an indication that a drop station is ready to be emptied of reusable food containers; and
providing, by the at least one processor, a notification to a mobile device of personnel responsible for emptying the drop station.

14. A food container management system, comprising:
at least one nontransitory processor-readable storage medium that stores at least one of instructions or data; and
at least one processor operatively coupled to the at least one nontransitory processor-readable storage medium, in operation the at least one processor:
receives a request for a plurality of reusable food containers from a vendor;
logically associates each of a plurality of reusable food containers with a vendor account of the vendor in the at least one nontransitory processor-readable storage medium responsive to receiving the request for the plurality of reusable food containers from the vendor;
receives a request for use of one of the plurality of reusable food containers associated with the vendor account from a user; and
logically associates the one of the reusable food containers with a user account of the user in the at least one nontransitory processor-readable storage medium responsive to receiving the request for use of the one of the reusable food containers.

15. The food container management system of claim 14 wherein the at least one processor:
receives an indication that the user has returned the reusable food container to a drop station after use of the reusable food container; and
logically dis-associates the returned reusable food container with the user account of the user.

16. The food container management system of claim 15 wherein the at least one processor:
receives an indication from a mobile device that has read a machine readable symbol associated with the reusable food container; or
receives an indication from a reader of the drop station that has read a machine readable symbol associated with the reusable food container.

17. The food container management system of claim 14 wherein the at least one processor receives an identifier associated with the one of the plurality of reusable food containers from a mobile device of the user.

18. The food container management system of claim 17 wherein the at least one processor receives an identifier obtained by the mobile device of the user by reading a machine readable symbol associated with the reusable food container.

19. The food container management system of claim 18 wherein the machine readable symbol comprises at least one of a barcode, a QR code, or an RFID tag associated with the reusable food container.

20. A nontransitory processor-readable storage medium that stores at least one of instructions or data that, when executed by at least one processor, cause the at least one processor to:
receive a request for a plurality of reusable food or beverage related products from a vendor;
logically associate each of a plurality of reusable food or beverage related products with a vendor account of the vendor in the at least one nontransitory processor-readable storage medium responsive to receiving the request for the plurality of reusable food or beverage related products from the vendor;
receive a request for use of one of the plurality of reusable food or beverage related products associated with the vendor account from a user; and
logically associate the one of the reusable food or beverage related products with a user account of the user in the at least one nontransitory processor-readable storage medium responsive to receiving the request for use of the one of the reusable food or beverage related products.
